(19) United States
(12) Patent Application Publication
(10) Pub. No.: US 2016/0109073 A1
(43) Pub. Date: Apr. 21, 2016

(54) LIGHT-EMITTING DEVICE

(71) Applicant: SHARP KABUSHIKI KAISHA, Osaka-shi (JP)

(72) Inventors: Mami MORISHITA, Osaka-shi (JP); Tatsuya RYOHWA, Osaka-shi (JP)

(21) Appl. No.: 14/891,095

(22) PCT Filed: Feb. 18, 2014
(86) PCT No.: PCT/JP2014/053727

§ 371 Date: Nov. 13, 2015

(30) Foreign Application Priority Data
May 28, 2013 (JP) 2013-111855

(51) Int. Cl. F21K 99/00; F21V 9/06; G02B 1/118; F21V 9/16

(52) U.S. Cl. CPC F21K 9/56; F21V 9/16; F21V 9/06; G02B 1/118; Y10S 977/774; Y10S 977/95; B82Y 20/00

(57) ABSTRACT

A light-emitting device including a light source to emit primary light and a light-emitting section provided with a transparent member containing first nanoparticles which absorb at least part of the primary light and emit secondary light, wherein the light-emitting section is provided with an antireflective structure section disposed on at least part of an outer surface of the transparent member. The antireflective structure section may contain ultraviolet absorptive second nanoparticles.

### TECHNICAL FIELD

The present invention relates to a light-emitting device which includes a light-emitting section containing nanoparticles and which is suitable for illumination and the like.

### BACKGROUND ART

At present, illumination is used in various forms. For example, the illumination is put on the ceiling of a room to illuminate the whole room with sufficient luminance or is put at a place in need of light with appropriate luminance. The latter is preferable from the viewpoint of energy conservation, as a matter of course. The illumination put on a desk, a floor, and the like is required to be transparent to suppress reduction in visibility because of conspicuousness of the illumination or feeling that the surrounding space is narrow when not in use.

Japanese Unexamined Patent Application Publication No. 2004-229817 (PTL 1) describes a light-emitting block which is formed from transparent or semitransparent resin containing a rare earth complex or an organic dye to emit phosphorescence by being irradiated with excitation light with a predetermined wavelength and which can be used for toys, illumination, and the like.

### CITATION LIST

### Patent Literature

PTL 1: Japanese Unexamined Patent Application Publication No. 2004-229817

### SUMMARY OF INVENTION

### Technical Problem

The light-emitting device, e.g., the light-emitting block described in PTL 1, including a light-emitting section, in which the phosphor is sealed with the transparent resin, has a problem that external light is reflected at the transparent resin surface to cause reflections of the external light when not in use and, as a result, there is a feeling that the surrounding space is narrow because of conspicuousness of the illumination regardless of the light-emitting device being primarily formed from a transparent material.

Accordingly, it is an object of the present invention to provide a light-emitting device including a light-emitting section containing nanoparticles, wherein the light-emitting device is inconspicuous when not in use (when the light is turned off) and there is a feeling that the space surrounding the installed light-emitting device is broad.

### Solution to Problem

The present invention includes the following light-emitting device.

[1] A light-emitting device including

a light source to emit primary light, and

a light-emitting section provided with a transparent member containing first nanoparticles which absorb at least part of the above-described primary light and emit secondary light,

wherein the above-described light-emitting section is provided with an antireflective structure section disposed on at least part of an outer surface of the above-described transparent member.

[2] The light-emitting device according to the item [1], wherein the above-described antireflective structure section contains ultraviolet absorptive second nanoparticles.

[3] The light-emitting device according to the item [2], wherein the above-described second nanoparticle is a nanoparticle phosphor which emits visible light by absorbing the ultraviolet light.

[4] The light-emitting device according to any one of the items [1] to [3],

wherein the above-described light source and the above-described transparent member are connected with a light guide member, and

the above-described primary light is transmitted to the inside of the above-described transparent member.

[5] The light-emitting device according to any one of the items [1] to [4], wherein the above-described antireflective structure section is disposed on at least an outer surface, from which the above-described secondary light outgoes, of the above-described transparent member.

### Advantageous Effects of Invention

According to the present invention, a light-emitting device can be provided, wherein the light-emitting device is inconspicuous when not in use and there is a feeling that the space surrounding the installed light-emitting device is broad.

### BRIEF DESCRIPTION OF DRAWINGS

FIG. 1 (a) is a sectional view schematically showing a light-emitting device according to a first embodiment of the present invention and FIG. 1 (b) is a magnified diagram of a region a shown in FIG. 1 (a).

FIG. 2 (a) is a sectional view schematically showing an example of a light-emitting device according to a second embodiment of the present invention and FIG. 2 (b) is a magnified diagram of a region b shown in FIG. 2 (a).

FIG. 3 (a) is a sectional view schematically showing another example of the light-emitting device according to the second embodiment of the present invention and FIG. 3 (b) is a magnified diagram of a region c shown in FIG. 3 (a).

FIG. 4 is a sectional view schematically showing a light-emitting device according to a third embodiment of the present invention.

FIG. 5 (a) is a sectional view schematically showing a light-emitting device according to a fourth embodiment of the present invention and FIG. 5 (b) is a magnified diagram of a region d shown in FIG. 5 (a).

FIG. 6 is a schematic perspective view showing a light-emitting device according to a fifth embodiment of the present invention.

### DESCRIPTION OF EMBODIMENTS

The present invention will be described below in detail with reference to the embodiments.

### First Embodiment

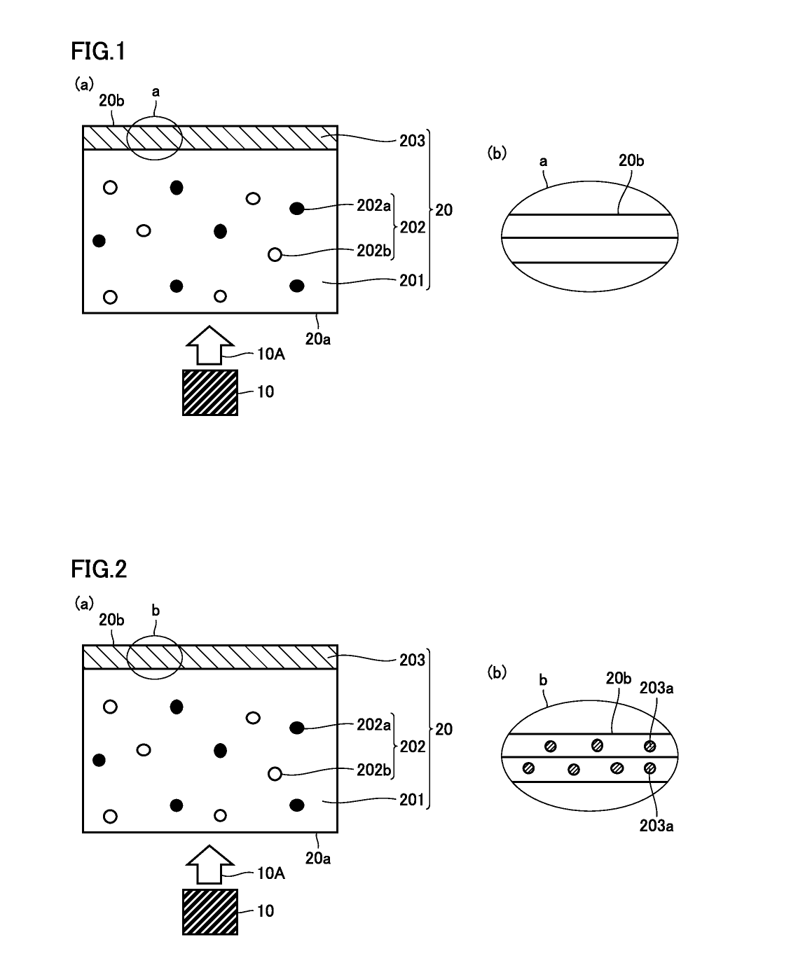

FIG. 1 (a) is a sectional view schematically showing a light-emitting device according to the present embodiment and FIG. 1 (b) is a magnified diagram of a region a shown in FIG. 1 (a). The light-emitting device shown in FIG. 1 is, for example, a light-emitting device which emits white light suitable for an illumination device, and includes a light source 10 to emit primary light 10A and a light-emitting section 20 provided with a transparent member 201 containing first nanoparticles 202 which absorb at least part of the primary light 10A and emit secondary light. In the light-emitting device shown in FIG. 1, the first nanoparticles 202 include red semiconductor nanoparticle phosphors 202a and green semiconductor nanoparticle phosphors 202b.

The light-emitting section 20 is provided with an antireflective structure section 203 disposed on at least part of an outer surface of the transparent member 201, specifically, on the outer surface, from which the secondary light from the first nanoparticles 202 outgoes. The light-emitting section 20 has a light incoming surface 20a, on which the primary light 10A from the light source 10 is incident, and a light outgoing surface 20b, from which the secondary light outgoes. In the light-emitting device shown in FIG. 1, the outer surface of the antireflective structure section 203 serves as the light outgoing surface 20b. The antireflective structure section 203 is a layer (or member) to prevent or suppress reflection of the external light.

In the case where the antireflective structure section 203 is disposed, it is possible to prevent or suppress occurrences of reflections of the external light due to the external light being reflected at the light outgoing surface 20b, while the transparency (visible light transmission property) of the light-emitting section 20 is ensured when the light-emitting device is not in use. Therefore, it is possible to improve the visibility and allow the light-emitting device to become inconspicuous when the light-emitting device is not in use. Consequently, a feeling that the space surrounding the installed light-emitting device is broad can be produced and, in addition, in the case where the light-emitting device is used as an illumination device and the like, the look and feel thereof as an interior can also be enhanced.

(Light Source)

The light source (excitation light source) 10 emits the primary light 10A to be absorbed by the first nanoparticles 202. The primary light 10A has a luminous peak wavelength which at least overlaps with the absorption wavelength of the first nanoparticle 202. As for the light source 10 to emit such primary light 10A, a light source having a luminous wavelength of from an ultraviolet region to a blue region is used usually. For example, a light-emitting diode (LED), a laser diode (LD), and the like can be used. Also, an organic electroluminescent light-emitting element and an inorganic electroluminescent light-emitting element, and the like may be used. For example, GaN based LED and LD can be used as LED and LD favorably. Only one light source 10 may be used or at least two thereof may be used in combination.

(Transparent Member)

The transparent member 201 is a member in which first nanoparticles 202 are contained and dispersed, put another way, a member to seal the first nanoparticles 202. At least part of the outer surface of the transparent member 201 is the light incoming surface 20a, on which the primary light 10A from the light source 10 is incident, at least part of the primary light 10A incident from the light incoming surface 20a is absorbed by the first nanoparticles 202 and, thereby, the first nanoparticles 202 emit light. The light outgoing surface 20b of the light-emitting section 20 can be disposed on, for example, the surface opposite to the light incoming surface 20a.

The transparent member 201 which can make up most of the light-emitting section 20 has transparency and is preferably transparent. Consequently, the light-emitting device can have a light transmission property when not in use and, therefore, there is an advantage from the viewpoint of inconspicuousness of the light-emitting device. The transparence refers to that the visible light transmittance is 90% or more. The material constituting the transparent member 201 is not specifically limited. For example, light-transmitting (transparent) resins, e.g., acrylic resins and silicone resins, and glass materials can be used. Most of all, it is preferable that acrylic resins (for example, polylauryl methacrylate) be used because the dispersibility of the first nanoparticles 202 is good.

As for the first nanoparticles 202 dispersed in the transparent member 201, semiconductor nanoparticle phosphors can be used. The semiconductor nanoparticle phosphor is a nanosized semiconductor substance and is a substance exhibiting a quantum confinement effect. Such a quantum dot adsorbs the primary light from an excitation source and releases energy corresponding to the energy band gap of the semiconductor nanoparticle phosphor when an energy excited state is reached. Therefore, the energy band gap can be adjusted by adjusting the particle size or the material composition of the semiconductor nanoparticle phosphor, so that phosphorescence with various wavelengths can be utilized. The semiconductor nanoparticle phosphor is a particle having a particle diameter within the range of 1 to 100 nm, and further preferably 2 to 20 nm and does not scatter the visible light, so that the transparency (visible light transmission property) of the light-emitting section 20 when the light-emitting device is not in use can be ensured.

In the light-emitting device shown in FIG. 1, two types of semiconductor nanoparticle phosphors are used as the first nanoparticles 202, although not limited to this. Only one type of semiconductor nanoparticle phosphor may be used, for example, only a yellow semiconductor nanoparticle phosphor may be used. Alternatively, at least three types of semiconductor nanoparticle phosphors may be used. As for the first nanoparticle 202, semiconductor nanoparticle phosphors, e.g., InP, InN, and CdSe, can be used preferably. The types and the combination of the semiconductor nanoparticle phosphor used are adjusted in accordance with the predetermined hue of the secondary light emitted from the light-emitting section 20.

The concentration of the first nanoparticles 202 dispersed in the transparent member 201 is usually 0.001 to 10 percent by weight, and preferably 0.1 to 5 percent by weight, where the total weight of the transparent member 201 and the first nanoparticles 202 is specified to be 100%.

(Antireflective Structure Section)

The antireflective structure section 203 is a layer (or member) to prevent or suppress reflection of the external light. The antireflective structure section 203 is not specifically limited, although an antireflection layer formed from a multilayer structure of optical thin films, a layer having an uneven surface (for example, a layer having a moth-eye structure), and the like can be used favorably. FIG. 1 shows an example in which a multilayer structure of optical thin films is used. As with the transparent member 201, the antireflective structure section 203 has a light transmission property and is preferably transparent.

Specifically, AG (anti-glare) films and AR (antireflection) films can be used. As for the AG film, reflections are prevented by utilizing scattering of reflected light through the use of unevenness formed on the surface by putting particles into a hard coat resin and internal scattering due to a difference in refractive index between the hard coat resin and the particles.

On the other hand, the AR film is a film including an antireflection layer formed from a multilayer structure of optical thin films and reduces the reflected light intensity through the use of optical interference. The incident light is reflected at the surface of the antireflection layer and the interface between the light-emitting section and the antireflection layer. The AR film can reduce the reflected light through the use of canceling of the surface reflected light and the interface reflected light with each other, where the phases of them are allowed to become reverse to each other.

In the case where the refractive index (n₁) and the film thickness (d₁) of the antireflection layer and the refractive index (n₂) of the transparent member 201 of the light-emitting section 20 satisfy the following formulae (1) and (2):

n₁²=n₀×n₂ (1)

[n₀ is the refractive index of an outside region of the antireflection layer]

n₁×d₁=λ/4 (2)

the reflectance at a wavelength λ (nm) becomes 0%. It is understood from the formula (2) that the antireflection effect has dependence on the wavelength and also has dependence on the film thickness of the antireflection layer.

In general, the reflectance R (%) of the light at the interface between bodies having different refractive indices n is represented by the following formula (3):

R=[(n₁−n₂)²/(n₁+n₂)²]×100 (3)

where the refractive indices n of the two substances constituting the interface are defined as n₁ and n₂, respectively.

The above-described formula (3) indicates that the reflectance R decreases at the interface between substances exhibiting a small refractive index difference Δn=n₁−n₂ and, conversely, the reflectance R increases at the interface between substances exhibiting a large refractive index difference. Put another way, it can be said that the light senses the refractive index difference Δn at the interface between substances and changes the reflectance depending on the magnitude of the difference.

Here, in the case where a fine uneven structure with a period smaller than or equal to the wavelength of the light is formed at the interface, the refractive index n sensed by the external light changes gradually from the outer surface portion toward the inside, and the external light advances while sensing that the refractive index difference Δn is not present there. Put another way, the refractive index difference Δn is not present, that is, reflection does not occur.

Likewise, in the case where the phosphorescence, which is transmitted or passed through the transparent member 201, outgoes from the antireflective structure section 203 to the outside (air), it looks as if the refractive index difference Δn between the transparent member 201 and the air is not present at the interface, so that the efficiency of taking out of the phosphorescence from the transparent member 201 to the outside (air) is improved.

In the case where the antireflective structure section 203 has a fine surface uneven structure, as for the shapes of protrusions constituting the surface uneven structure, various shapes, such as, a cone shape, a pyramid shape, and a temple bell shape, may be employed in accordance with the forming condition of the surface uneven structure. Also, flat portions may be present between the protrusions or no flat portion may be present in accordance with the forming condition of the surface uneven structure. In the present invention, the shape of the surface uneven structure is not specifically limited insofar as the periodic structure smaller than or equal to the wavelength of the visible light is ensured. However, it is preferable that flat portions which may be present at the interface between the surface uneven structure of the antireflective structure section 203 and the transparent member 201 be minimized because the antireflection effect is further enhanced.

The location of disposition of the antireflective structure section 203 is not specifically limited insofar as the location is on at least part of the outer surface of the transparent member 201. However, it is preferable that the antireflective structure section 203 be disposed on at least the outer surface, from which the secondary light from the first nanoparticles 202 outgoes. This is because the light outgoing surface 20b is outwardly present at a very easy-to-see location and the effect of the present invention (an effect of improving the visibility through the light-emitting device to facilitate becoming inconspicuous) can be obtained very efficiently by preventing or suppressing reflection of the external light at the light outgoing surface 20b. As a matter of course, the antireflective structure section 203 may be disposed on the outer surface other than the outer surface, from which the secondary light outgoes. More preferably, the antireflective structure section 203 is disposed on the entire outer surface, from which the secondary light outgoes.

In this regard, in the light-emitting device shown in FIG. 1 (the same goes for FIGS. 2 to 5), the side surfaces of the transparent member 201 (outer surfaces other than the light incoming surface 20a and the light outgoing surface 20b) are covered with, for example, a casing or protective member, although not shown in the drawing, and therefore, do not serve as the light outgoing surface of the secondary light. Such covered side surfaces of the transparent member 201 are not necessarily provided with the antireflective structure section 203 because reflection of the external light does not occur. Also, the light outgoing surface 20b of the light-emitting section 20 is not necessarily disposed on the surface opposite to the light incoming surface 20a and may be formed on the side surface of the transparent member 201 in place of the surface concerned or together with the surface concerned.

The shape of the light-emitting section 20 is not specifically limited and may be a geometric, three-dimensional shape, for example, a cube, a rectangular parallelepiped, a sphere, or a cone, or other complicated three-dimensional shape, for example, an animal or a doll.

### Second Embodiment

FIG. 2 (a) is a sectional view schematically showing an example of a light-emitting device according to the present embodiment and FIG. 2 (b) is a magnified diagram of a region b shown in FIG. 2 (a). The light-emitting device shown in FIG. 2 is the same as the above-described first embodiment except that not only the transparent member 201 contains first nanoparticles 202 but also the antireflective structure section 203 contains second nanoparticles 203a.

The second nanoparticles 203a are composed of ultraviolet absorptive second nanoparticles. As for the ultraviolet absorptive second nanoparticles 203a, dope type or core/shell type nanoparticles, for example, wide gap semiconductor nanoparticles, e.g., InAs/ZnS, InAs/ZnO, InAs/TiO₂, ZnO:Mg, ZnO:Be, GaN, and ZnS; and YVO₄ and other inorganic phosphor nanoparticles can be used. The second nanoparticles 203a may be formed from only one type of nanoparticles or may be formed from at least two types of nanoparticles. Also, the first nanoparticles 202 and the second nanoparticles 203a may be made from the same material or be made from different materials. The first nanoparticle 202 and the second nanoparticle 203a may have the same particle diameter or different particle diameters.

In one example of preferable combinations of phosphor particles used, red semiconductor nanoparticle phosphors 202a and green semiconductor nanoparticle phosphors 202b are used as the first nanoparticles 202 and blue semiconductor nanoparticle phosphors are used as the second nanoparticles 203a. In this case, red light and green light emitted from the first nanoparticles 202 are not absorbed by the second nanoparticles 203a when the light-emitting device is used. Therefore, the hue and the luminance are not adversely affected in, for example, illumination use.

In the case where the external light includes short wavelength light, e.g., ultraviolet light, the short wavelength light can penetrate into the inside of the transparent member 201 because the antireflective structure section 203 is disposed. In this case, the transparent member 201 and the first nanoparticles 202 contained therein may be degraded by the short wavelength light. According to the present embodiment, the second nanoparticles 203a are contained and dispersed in the antireflective structure section 203, so that the short wavelength light, e.g., ultraviolet light, in the external light is absorbed by the second nanoparticles 203a. Therefore, penetration of the short wavelength light into the inside of the transparent member 201 can be prevented. Consequently, degradation of the transparent member 201 and the first nanoparticles 202 contained therein can be prevented.

It is preferable that the second nanoparticles 203a be dispersed in the entire plane of the antireflective structure section 203. Also, the second nanoparticles 203a may be dispersed in the entire antireflective structure section 203 in the thickness direction or may be partly dispersed.

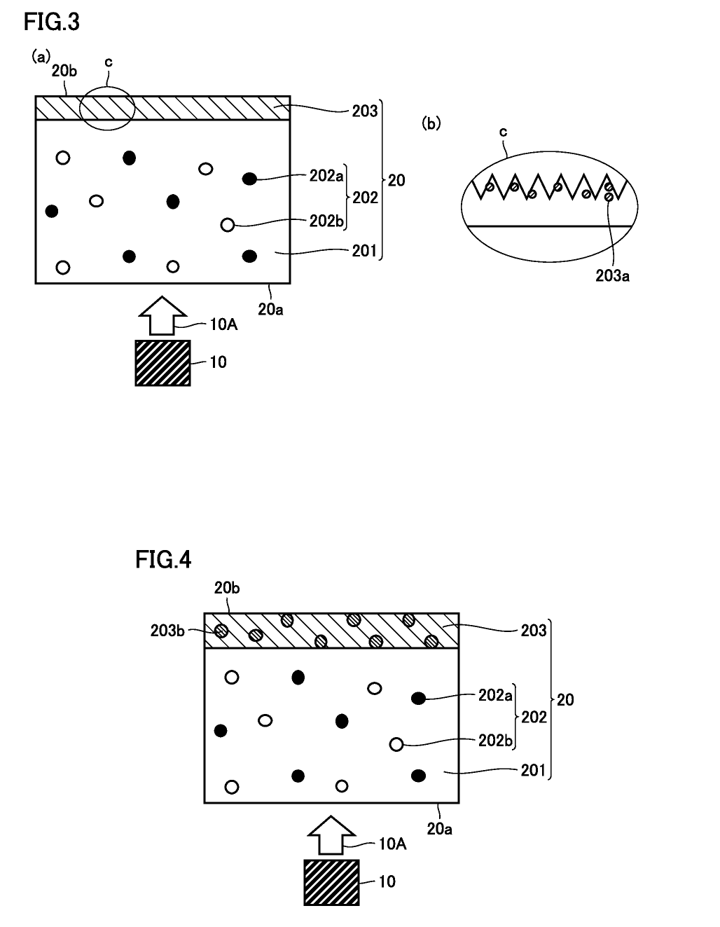

FIG. 3 (a) is a sectional view schematically showing another example of the light-emitting device according to the present embodiment and FIG. 3 (b) is a magnified diagram of a region c shown in FIG. 3 (a). The light-emitting device shown in FIG. 3 is an example in which a layer having unevenness on the surface is used as the antireflective structure section 203 and the second nanoparticles 203a are dispersed in the convex portions of the surface uneven structure. The same effects as those of the light-emitting device shown in FIG. 2 can be obtained by such a configuration. In the case where the second nanoparticles 203a are dispersed in the convex portions of the surface uneven structure, the area of the surface in contact with the air increases, so that improvement of the heat dissipation effect of the light-emitting device can be expected.

In the light-emitting device shown in FIG. 3, the second nanoparticles 203a may be dispersed in portions other than the convex portions of the antireflective structure section 203, as a matter of course.

### Third Embodiment

FIG. 4 is a sectional view schematically showing a light-emitting device according to the present embodiment. The light-emitting device shown in FIG. 4 is the same as the above-described second embodiment except that ultraviolet absorptive nanoparticles which emit visible light on the basis of absorption of the ultraviolet light are used as second nanoparticles 203b contained in the antireflective structure section 203.

As for the second nanoparticles 203b which emit visible light on the basis of absorption of the ultraviolet light, dope type or core/shell type semiconductor nanoparticle phosphors, for example, CdSe/ZnS, CdSe/ZnO, CdSe/TiO₂, CdS/ZnS, CdS/ZnO, CdS/TiO₂, ZnSe/ZnS, ZnSe/ZnO, ZnSe/TiO₂, InP/GaN, InP/ZnS, InP/ZnO, and InP/TiO₂, preferably wide gap semiconductor nanoparticles, e.g., InN/GaN, InN/ZnS, InN/ZnO, and InN/TiO₂; and YVO₄:Bi³⁺, Eu³⁺, YVO₄:Eu³⁺, and other inorganic phosphor nanoparticles can be used. The second nanoparticles 203b may be formed from only one type of nanoparticles or may be formed from at least two types of nanoparticles. Also, the first nanoparticles 202 and the second nanoparticles 203b may be made from the same material or be made from different materials. The first nanoparticle 202 and the second nanoparticle 203b may have the same particle diameter or different particle diameters.

In one example of preferable combination of phosphor particles used, red semiconductor nanoparticle phosphors 202a and green semiconductor nanoparticle phosphors 202b are used as the first nanoparticles 202 and blue semiconductor nanoparticle phosphors are used as the second nanoparticles 203b. In this case, red light and green light emitted from the first nanoparticles 202 are not absorbed by the second nanoparticles 203b when the light-emitting device is used. Therefore, the hue and the luminance are not adversely affected in, for example, illumination use.

According to the present embodiment, the same effects as those of the above-described second embodiment can be obtained. In addition, In the case where the external light is applied to the antireflective structure section 203, the light-emitting section 20 (antireflective structure section 203) is allowed to emit faint light even when the light-emitting device is not in use. This is advantageous from the viewpoints that highly decorative luminaires can be provided and collision with luminaires is avoided easily.

### Fourth Embodiment

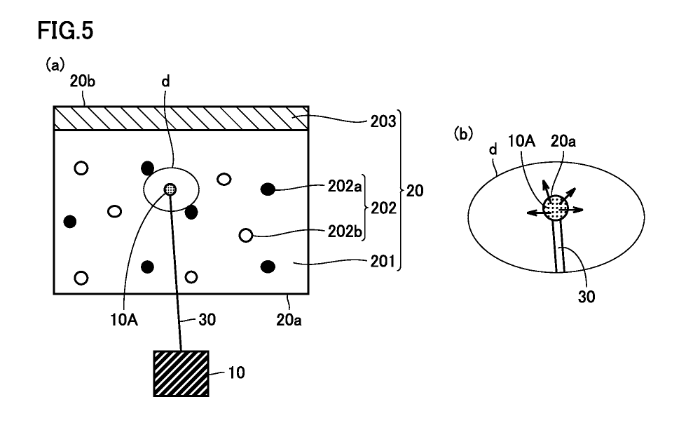

FIG. 5 (a) is a sectional view schematically showing a light-emitting device according to the present embodiment and FIG. 5 (b) is a magnified diagram of a region d shown in FIG. 5 (a). The light-emitting device shown in FIG. 5 is a modified example of the light-emitting device according to the above-described first embodiment and is characterized in that the light source 10 and the inside of the transparent member 201 are connected with a light guide member 30 and the primary light 10A is transmitted to the inside of the transparent member 201 in contrast to the first embodiment in which the surface opposite to the light source 10 of the transparent member 201 is specified to be the light incoming surface 20a and the primary light 10A is applied thereto.

In the present embodiment, the light incoming surface 20a is present in the inside of the transparent member 201. An optical fiber and the like can be used as the light guide member 30.

### Fifth Embodiment

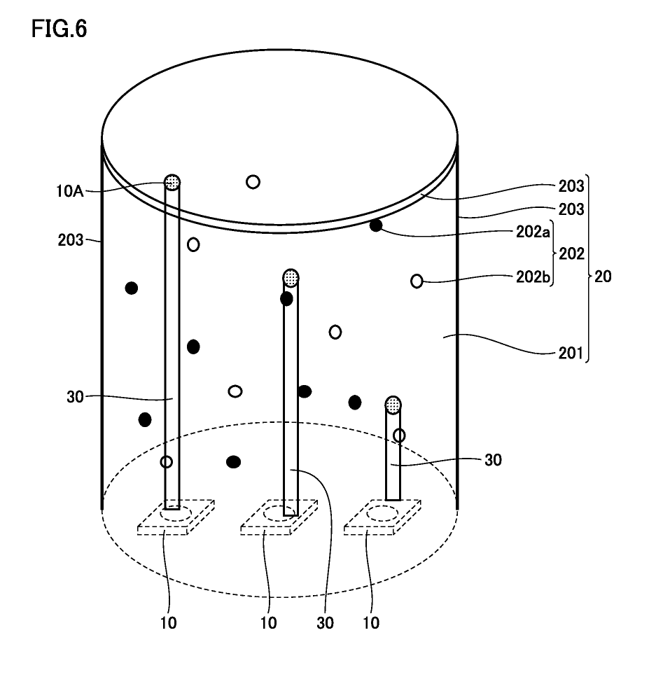

FIG. 6 is a schematic perspective view showing a light-emitting device according to the present embodiment. The light-emitting device shown in FIG. 6 is the same as the above-described fifth embodiment except that the light-emitting section 20 has a circular columnar shape, not only a flat outer surface opposite to the light incoming surface but also an outer surface (side surface) constituting a curved surface serves as a light outgoing surface, the antireflective structure sections 203 are disposed on the above-described flat outer surface and outer surface constituting the curved surface.

As described above, in the present invention, the outer shape of the light-emitting section 20 is not specifically limited and can be various shapes, for example, rectangular shapes, e.g., a cube and a rectangular parallelepiped, and circular columnar shapes. It is preferable that the antireflective structure section 203 be disposed on at least the outer surface, from which the secondary light from the first nanoparticles 202 outgoes, regardless of the outer shape of the light-emitting section 20.

### REFERENCE SIGNS LIST

10 light source, 10A primary light, 20 light-emitting section, 20a light incoming surface, 20b light outgoing surface, 30 light guide member, 201 transparent member, 202 first nanoparticle, 202a red semiconductor nanoparticle phosphor, 202b green semiconductor nanoparticle phosphor, 203 antireflective structure section, 203a, 203b second nanoparticle

1. A light-emitting device comprising:
a light source to emit primary light; and
a light-emitting section provided with a transparent member containing first nanoparticles which absorb at least part of the primary light and emit secondary light,
wherein the light-emitting section is provided with an antireflective structure section disposed on at least part of an outer surface of the transparent member.

2. The light-emitting device according to claim 1, wherein the antireflective structure section contains an ultraviolet absorptive second nanoparticles.

3. The light-emitting device according to claim 2, wherein the second nanoparticle is a nanoparticle phosphor which emits visible light by absorbing the ultraviolet light.

4. The light-emitting device according to claim 1,
wherein the light source and the transparent member are connected with a light guide member, and
the primary light is transmitted to the inside of the transparent member.

5. The light-emitting device according to claim 1, wherein the antireflective structure section is disposed on at least an outer surface, from which the secondary light outgoes, of the transparent member.
